(19) United States
(12) Patent Application Publication
(10) Pub. No.: US 2015/0025808 A1
(43) Pub. Date: Jan. 22, 2015

(54) Methods and Systems for Processing Test Results Based on Patient-Specific Data and Reference Data

(71) Applicant: IDEXX Laboratories, Inc., Westbrook, ME (US)

(72) Inventor: Jason Aguiar, Westbrook, ME (US)

(21) Appl. No.: 13/944,460

(22) Filed: Jul. 17, 2013

(51) Int. Cl. G06F 19/00

(52) U.S. Cl. CPC G06F 19/3487; G06F 19/322
USPC 702/19

(57) ABSTRACT

Methods and systems for processing test results based on patient-specific data and reference data are provided. An example method includes processing a result of a diagnostic test performed on a patient based on reference data that is based on testing of a group of patients. The method also includes processing the result based on patient-specific data that includes previous test results of the diagnostic test previously performed on the patient, and providing an indication indicative of an abnormal test result based on the result being in a normal range of the reference data and having a variance from the patient-specific data of a threshold amount. In another example, a method includes providing an indication indicative of a normal test result based on the result being outside a normal range of the reference data and being between an upper limit and a lower limit of the patient-specific data.

### BACKGROUND

Unless otherwise indicated herein, the materials described in this section are not prior art to the claims in this application and are not admitted to be prior art by inclusion in this section.

In the field of medicine, health care providers use test results to diagnose disease, determine prognosis, and monitor a patient's treatment or health status. Medical decisions can be based on simple tests performed at the point of care. Test results are typically interpreted according to a manufacturer's instructions that developed the test. Quick reference guides or color charts may be provided to help interpret results, for example.

Test results may be quantitative, qualitative, or a combination of the two with a number result that can be interpreted into a non-numeric result. Typical quantitative results include number values produced by a test device or instrument. These results give an amount of substance being measured and are reported in specific measurement units. Typical qualitative results may be interpreted as positive, negative, reactive, non-reactive, or invalid, for example. These results identify a presence or absence of a particular substance, condition, or microbial organism.

Patient test results may be configured in an output report using standardized reporting techniques, and being based on reference values of known test results corresponding to a given quantitative and/or qualitative result.

### SUMMARY

In one example, a method is provided that comprises obtaining, by a computing device, a result of a diagnostic test performed on a patient. The method also comprises comparing, by the computing device, the result based on patient-specific data, and the patient-specific data includes one or more previous test results of the diagnostic test previously performed on the patient. The method further comprises providing, by the computing device, an indication indicative of an abnormal test result based on the result being in a normal range of reference data and having a variance from the patient-specific data of a threshold amount. The reference data is based on testing of a group of patients.

In another example, a computer readable storage medium having stored therein instructions, that when executed by a computing device, cause the computing device to perform functions. The functions may comprise obtaining a result of a diagnostic test performed on a patient. The functions also comprise comparing the result based on patient-specific data, and the patient-specific data includes one or more previous test results of the diagnostic test previously performed on the patient. The functions also comprise providing an indication indicative of an abnormal test result based on the result being in a normal range of reference data and having a variance from the patient-specific data of a threshold amount. The reference data is based on testing of a group of patients.

In still another example, a system is provided that comprises at least one processor, and data storage comprising instructions executable by the at least one processor to cause the system to perform functions. The functions may comprise obtaining a result of a diagnostic test performed on a patient. The functions also comprise comparing the result based on patient-specific data, and the patient-specific data includes one or more previous test results of the diagnostic test previously performed on the patient. The functions also comprise providing an indication indicative of an abnormal test result based on the result being in a normal range of reference data and having a variance from the patient-specific data of a threshold amount. The reference data is based on testing of a group of patients.

In yet another example, another method is provided that comprises obtaining, by a computing device, a result of a diagnostic test performed on a patient. The method also comprises comparing, by the computing device, the result based on patient-specific data, and the patient-specific data includes one or more previous test results of the diagnostic test previously performed on the patient. The method also comprises providing, by the computing device, an indication indicative of a normal test result based on the result being outside a normal range of reference data and being between an upper limit and a lower limit of the patient-specific data. The reference data is based on testing of a group of patients.

These as well as other aspects, advantages, and alternatives, will become apparent to those of ordinary skill in the art by reading the following detailed description, with reference where appropriate to the accompanying figures.

### BRIEF DESCRIPTION OF THE FIGURES

FIG. 1 illustrates an example system for processing medical data.

FIG. 2 is a block diagram of an example method to process test results based on patient specific data.

FIG. 3 is a block diagram of another example method to process test results based on patient specific data.

FIG. 4 is an example plot for canine patients sampled.

FIG. 5 is an example plot for feline patients sampled.

FIGS. 6A-6B illustrate example charts of patients that have test results that remain in the reference interval range as well as between the UCL and LCL determined for the specific patient.

FIGS. 7A-7B illustrate example charts of patients that have test results that breach both the reference interval range as well as the UCL determined for the specific patient.

FIGS. 8A-8B illustrate example charts of patients that have test results that breach the reference interval range, but generally remain between the UCL and LCL determined for the specific patient.

FIGS. 9A-9B illustrate example charts of patients that have test results that breach the UCL determined for the specific patient, but generally remain within the reference interval.

FIG. 10 illustrates another example chart of a patient that has test results that remain within the UCL and LCL determined for the specific patient, and within the reference interval.

### DETAILED DESCRIPTION

The following detailed description describes various features and functions of the disclosed systems and methods with reference to the accompanying figures. In the figures, similar symbols identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein.

Within examples, methods and systems for processing test results based on patient-specific data and reference data are provided. An example method includes obtaining a result of a diagnostic test performed on a patient. The method also includes comparing the result to patient-specific data that includes previous test results of the diagnostic test previously performed on the patient, and providing an indication indicative of an abnormal test result based on the result being in a normal range of reference data and having a variance from the patient-specific data of a threshold amount. In some examples, reference data includes data from testing of a group of patients. In another example, a method includes providing an indication indicative of a normal test result based on the result being outside a normal range of the reference data and being between an upper limit and a lower limit of the patient-specific data.

In some examples, individual patient values can be processed to identify trends for abnormalities, and indications may be triggered even when the values are within typically accepted limits of reference data.

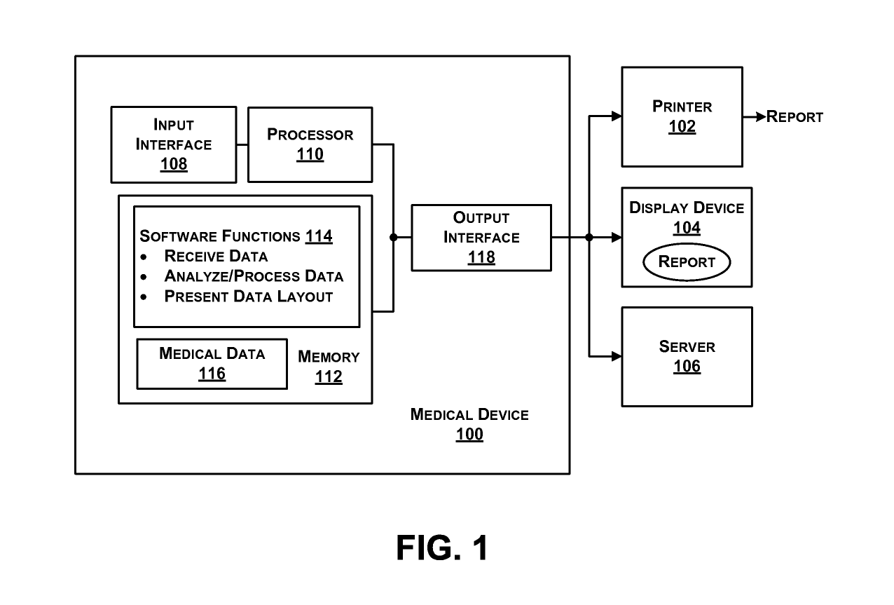

Referring now to the figures, FIG. 1 illustrates an example system for processing medical data. The system includes a medical device 100 that outputs to a printer 102, a display device 104 (e.g., a computer monitor), a server 106, or other computing devices (not shown).

The medical device 100 includes an input interface 108 that receives medical readings from a patient, such as a person or animal, or that receives medical data from other medical devices or stored medical data from a server, for example. In addition, the input interface 108 may include any standard medical interface for collecting desired medical readings from a patient, either human or animal.

The input interface 108 may be coupled to a processor 110 to provide the received data to the processor 110. The input interface 108 may also receive inputs from a user including instructions for processing the medical readings. The processor 110 accesses memory 112 to execute any of software functions 114 stored therein, such as to receive the medical readings, analyze and process the readings, and to present the processed or other generated data to the printer 102, the display device 104, or server 106, for example. The processor 110 may further access the memory 112 to retrieve other stored medical data 116, or past medical results, and may combine the medical data 116 with the received medical readings to be output through an output interface 118. The output interface 118 may allow the medical device 100 to communicate with other devices. In some examples, the output interface 118 may also maintain and manage records of data received and sent by the medical device 100.

Further, the input interface 108 and the output interface 118 may be any standard computer interface and may include, for example, a keyboard. However, other interfaces may be used as well. In addition, the input interface 108 and the output interface 118 may be configured as wired (e.g., wired serial bus such as a universal serial bus or a parallel bus) or wireless connections (e.g., Bluetooth® radio technology, communication protocols described in IEEE 802.11 (including any IEEE 802.11 revisions), or Cellular technology (such as GSM, CDMA, UMTS, EV-DO, WiMAX, or LTE) among other possibilities.

A system bus or an equivalent system may also be provided to enable communications between various elements of the medical device 100, the printer 102, the display device 104, or the server 106.

The processor 110 may operate according to an operating system, which may be any suitable commercially available embedded or disk-based operating system, or any proprietary operating system. The processor 110 may comprise one or more smaller central processing units, including, for example, a programmable digital signal processing engine. The processor 110 may also be implemented as a single application specific integrated circuit (ASIC) to improve speed and to economize space.

The memory 112 may include main memory and secondary storage. The main memory may include random access memory (RAM). Main memory can also include any additional or alternative memory device or memory circuitry. Secondary storage can be provided as well and may be persistent long term storage, such as read only memory (ROM), optical or magnetic disks, compact-disc read only memory (CD-ROM), or any other volatile or non-volatile storage systems. The memory 112 may include more software functions than illustrated as well, for example, executable by the processor 110 to record or receive signals from a patient and interpret the signals as medical readings. The software functions 114 may be provided using machine language instructions or software with object-oriented instructions, such as the Java programming language. However, other programming languages (such as the C++ programming language for instance) could be used as well.

It will be apparent to those of ordinary skill in the art that the methods described herein may be embodied in a computer program product that includes one or more computer readable media, as described as being present within the medical device 100. For example, a computer readable medium can include a readable memory device, such as a hard drive device, a CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location. In some examples, the medical device 100 could include hardware objects developed using integrated circuit development technologies, or yet via some other methods, or the combination of hardware and software objects that could be ordered, parameterized, and connected in a software environment to implement different functions described herein. Also, the hardware objects could communicate using electrical signals, with states of the signals representing different data. It should also be noted that the medical device 100 generally executes application programs resident at the medical device 100 under the control of the operating system of the medical device 100.

The medical device 100 may be of the type provided by IDEXX Laboratories, Inc., of Westbrook, Me., USA. For example, the medical device 100 may be one of those within the IDEXX VetLab® Suite that delivers information on blood chemistries, proteinuria, electrolytes, hematology, endocrinology and blood gases. Such devices include the VetTest® instrument, the LaserCyte® hematology analyzer, the VetLyte® electrolyte analyzer, or the VetStat® blood gas analyzer, for example.

The medical device 100 may additionally or alternatively take the form of a hand-held device, laptop, personal computer, a workstation, or a server. The medical device 100 may include an input device, such as a keyboard and/or a two or three-button mouse, if so desired. One skilled in the art of computer systems will understand that the example embodiments are not limited to any particular class or model of computer employed for the medical device 100 and will be able to select an appropriate system.

The medical device 100 may be configured to output a medical report to the printer 102, the display device 104, and/or the server 106. Alternatively, the output can include a transmission (e.g. fax, e-mail) to a remote location (such as from a reference laboratory to a clinic). The server 106 may be an e-mail server, and can be configured to provide the medical report to identified e-mail accounts.

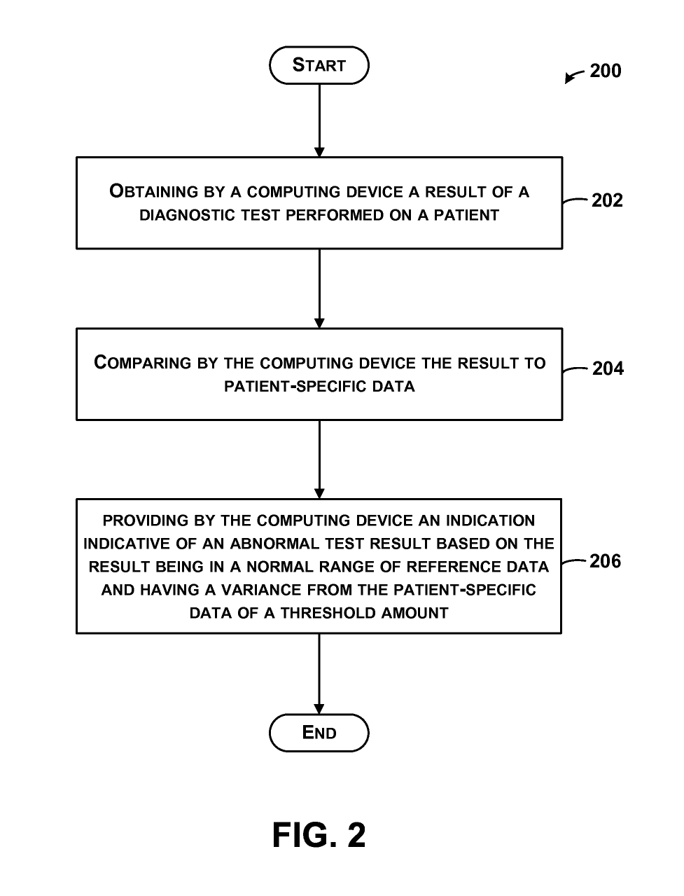

FIG. 2 is a block diagram of an example method 200 to process test results based on patient specific data, in accordance with at least some embodiments described herein. Method 200 shown in FIG. 2 presents an embodiment of a method that, for example, could be used or executed by the medical device 100, for example, and may be performed by a device, a server, or a combination of any other computing device components. Method 200 may include one or more operations, functions, or actions as illustrated by one or more of blocks 202-206. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for the method 200 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the method 200 and other processes and methods disclosed herein, each block in FIG. 2 may represent circuitry that is wired to perform the specific logical functions in the process.

At block 202, the method 200 includes obtaining by a computing device a result of a diagnostic test performed on a patient. Processing may include obtaining the result from a device that conducts the diagnostic test. The result may be received at a computing device, and the computing device may be configured to process the result based on stored reference data or based on reference data retrieved from another source (e.g., database, server, etc.).

The diagnostic test may be any test of a number of medical tests that can be performed on a patient. As one example, the diagnostic test includes a measurement of serum Creatinine in a canine patient.

At block 204, the method 200 includes comparing by the computing device the result to patient-specific data. The patient-specific data may include one or more previous test results of the diagnostic test previously performed on the patient. For example, the computing device may retrieve the patient-specific data from memory or a database, and compare the test result with previous test results of the patient. Previous test results of the patient may be compiled to establish baseline results for future comparisons. In this manner, by comparing a current test result with previous test results, it can be determined whether a change has occurred in the specific patient.

At block 206, the method 200 includes providing by the computing device an indication indicative of an abnormal test result based on the result being in a normal range of reference data and having a variance from the patient-specific data of a threshold amount. The reference data may be based on testing of a group of patients, and may be categorized into ranges of data considered to be representative of a low test result, a high test result, a normal test result, or any other label providing an indication of a medical evaluation of the test result. The reference data may be considered to be representative of such values of test results of a base population of patients. The reference data may be compiled over time due to testing of patients or promulgated by a standards organization or medical organization that provides guidelines or recommendations for ranges of values.

In some examples, the processing of the result includes comparing a value of the result with the reference data, and associating the value of the result with one of the low, normal, and high range of values designated with a matching value in the reference data. In this manner, the result can be compared to values in the reference data to provide an indication of the medical evaluation of the test result as compared to other previously tested patients.

Thus, even in instances in which the test result may be considered “normal” as compared to the standard/reference data, when the test result is outside of a variance from the patient-specific data, an indication can be provided. The indication may be provided in the form of a report, a message, an item on a graphical user interface (GUI) or display, etc. The indication can be interpreted as a warning that the patient has shown a change in the test result that otherwise may have been ignored since the test result was within the normal range of the reference data.

The variance from the patient-specific data and the threshold amount may be predetermined or preset values, and may be dependent on the type of diagnostic test performed and characteristics of the patient (such as height, weight, etc.). Examples are described below.

In some examples, the method 200 may also include determining a threshold variation between subsequent test results of the diagnostic test performed on the patient, and determining the variance of the patient-specific data to the threshold amount based on the threshold variation between subsequent test results. Thus, when two subsequent or possibly successive test results illustrate a variation between the two results, then a significant change may be interpreted warranting indication in a report.

In still other examples, the method 200 may further include determining a trend of the result of the diagnostic test performed on the patient and the previous test results of the diagnostic test previously performed on the patient. For example, the trend may be determined by processing the data and identifying whether values of the test result are increasing, decreasing, or remaining substantially steady over time. The indication may be provided based on the result being in the normal range of the reference data and also when the trend is in a direction toward outside the normal range of the reference data. As additional or alternative guidelines, an upper and/or a lower limit of a value of the result of the diagnostic test for the patient may be established and the indication may be provided based on the result being in the normal range of the reference data and also being outside of one of the upper and the lower limit of the value of the result of the diagnostic test. The upper and the lower limit may be established as having a standard deviation plus/minus an average of previous test results, for example. The upper and the lower limit may be established based on characteristics of the patient, such as mass/weight, height, gender, etc. Other examples are also described below.

In further examples, a moving range may be determined based on sequential test results for a patient, and this moving range used to calculate the one or more of an upper and lower limit, and the result can be processed to determine whether the patient's test result is within these limits. The patient result may also be further modified to produce a cumulative rolling average. In some examples, some values of the result may be ignored or considered as anomalies, such as values that are outside of the upper limit or values that are above a given threshold amount of a previous test result.

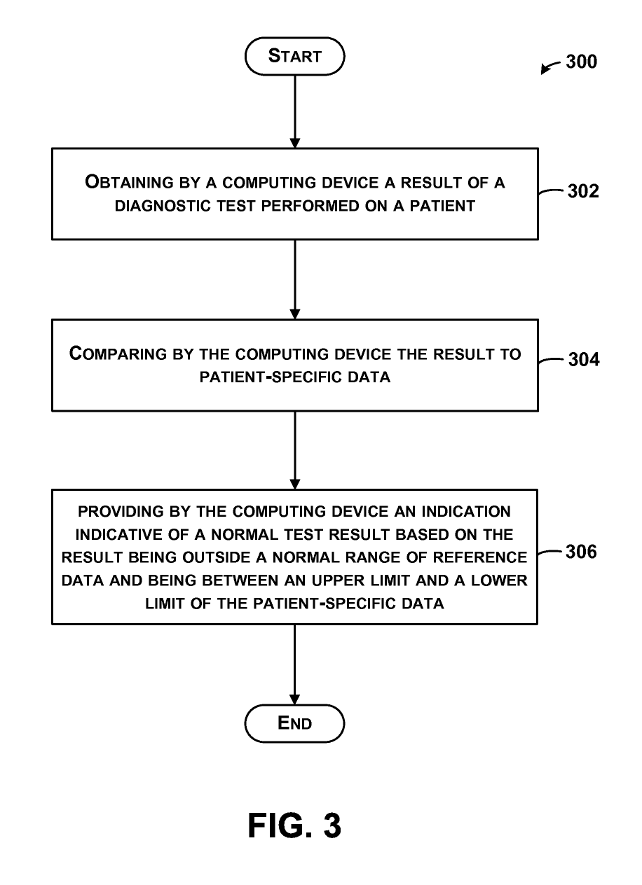

FIG. 3 is a block diagram of another example method 300 to process test results based on patient specific data, in accordance with at least some embodiments described herein. Method 300 shown in FIG. 3 presents an embodiment of a method that, for example, could be used or executed by the medical device 100, for example, and may be performed by a device, a server, or a combination of any other computing device components. Method 300 may include one or more operations, functions, or actions as illustrated by one or more of blocks 302-306. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

At block 302, the method 300 includes obtaining by a computing device a result of a diagnostic test performed on a patient, and at block 304, the method 300 includes comparing by the computing device the result to patient-specific data. Such functions may be the same or similar as discussed above with reference to the method 200 in FIG. 2.

At block 306, the method 300 includes providing by the computing device an indication indicative of a normal test result based on the result being outside a normal range of reference data and being between an upper limit and a lower limit of the patient-specific data. In this example, an indication of the test result being “normal” may be provided even though the test result is outside the normal range of reference data since the test result is still within an acceptable range of data for the specific patient. The upper limit and the lower limit of the patient-specific data may be representative of a range of values of the patient-specific data that are plus/minus a standard deviation of an average, for example.

Using example methods 200 or 300, patient value trending may be utilized with statistical methods to provide more diagnostic utility. There may be certain assays that are known to be problematic from a perspective of setting reference intervals for entire populations. For example, for animal patients, there may be differences from breed to breed or between genders that confound an ability to set a single reference interval that accomplishes what would be desired to provide relevant diagnostic information for a single patient. One such assay is serum Creatinine, for example, which has been seen to be a very precise assay within a single patient, but can suffer from large differences between patients.

Example methods described herein may be useful to overcome a high between-patient variation in an assay, such as Creatinine, to create limits that are reflective of a true range of variation that would be expected within a single patient and to create limits that are considered representative or relevant for that patient. Examples below may utilize methods adopted from the principles of statistical process control to provide patient-specific prediction limits to supplement or complement reference data results, and indications of test results based on comparison to the patient-specific and reference data can be performed to determine a level of variation that indicates a warning in a specific patient, independent of the population reference range.

As one example, serum Creatinine is useful to identify chronic kidney disease. However, there has been observed that a male patient reference range varies widely amongst all males, and also varies widely as compared to a female patient reference range. There is not much overlap between male and female patient values, and there are differences between patients of the same gender. Large differences between patients may contribute to a wide reference interval that may provide little information for those patients who regularly run below a cutoff value, for example. These characteristics may make diagnosis of chronic kidney disease difficult using only population reference data, as the population reference intervals may not appropriately reflect high precision within-patient.

Thus, certain analytes are observed to be precise within-patient, but show large differences from patient-to-patient. This characteristic may limit an effectiveness of a population reference data or interval for identifying changes within a single patient. Serum Creatinine has been shown to exhibit these characteristics, and use of individual patient limits shows positive results in identifying changes while results are still within the population reference interval, for example.

As an example, a study was performed using a sampling of fifty each Canine and Feline patients taken from a reference lab results database. Criteria for the patients included that all patients have a minimum of ten valid serum Creatinine results recorded in the database (no further discrimination based on time between values or the total span of time for these results), and a patient-matching algorithm was used to determine which results belong to the same patient based on matches with Patient Name, Owner Name, Species and Account Number. For all patients in the database with exact name matches and more than ten Creatinine results, the variability of those matching results was calculated, and fifty patients were then randomly sampled from the middle 50% of the population according to this variation. Sampling in this manner may help to ensure that sampling and subsequent variation estimates were not swayed too much by patients with excessively high or low variation representing special causes (i.e., patients who became sick (high variation), or patient's records that were duplicates or sample reruns that are not reflective of true within-patient variation).

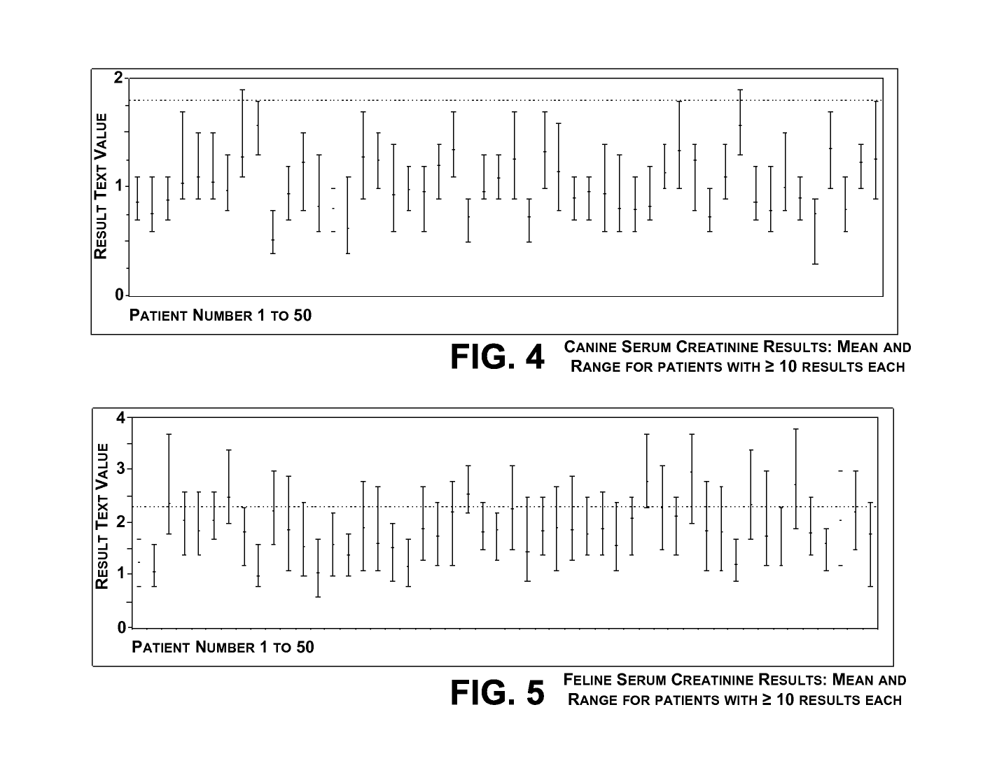

FIG. 4 is an example plot for canine patients sampled, and FIG. 5 is an example plot for feline patients sampled. Each patient's mean and range are shown, plotted against an example published reference range upper limit for the reference labs (shown as dotted line). For populations such as this, a total variation can be divided into constituent components of within-patient and between-patient variation as follows:

σ_{T}=\sqrt{(σ_{w}²+σ_{B}²)} Equation (1)

where σ_{T} is total variation, σ_{w} is within-patient variation, and σ_{B} is between-patient variation.

Table 1 below summarizes results of these calculations for the fifty-patient samples. For the canine patients, a between-patient variation contributes 60% of a total variation, and for feline patients the two components of variation are about equal.

TABLE 1

| Species | Component | Estimate (SD) | % of Total |
|---|---|---|---|
| Canine | Total | 0.3 | |
| | Within-Patient | 0.19 | 40% |
| | Between-Patient | 0.23 | 60% |
| Feline | Total | 0.58 | |
| | Within-Patient | 0.4 | 48% |
| | Between-Patient | 0.42 | 52% |

A reference change value (RCV), defined as a least difference that can be considered significant between serial results in a patient, is as follows:

RCV=\sqrt{2}*1.65*\sqrt{(σ_{w}²+σ_{B}²)} Equation (2)

Within some examples, a reference range may only be twice as large as a significant change value as defined by the variation in the population. For an example reference range of between 0.4-1.8, and an individual patient that exhibits test results of about 1.0, the patient would have to have serum Creatinine values about double before reaching the upper limit of the reference range. However, less than a doubling of serum Creatinine values may be a warning that a problem exists, and it would be beneficial to trigger an indication of a rise in the values for such a patient.

As seen in FIG. 4, canine individuals exhibit more patient-to-patient variation, and therefore have a relatively high between-patient variation when compared to the total reference range. For canines, these statistics show that the reference range may be too broad to be as predictive of within-dog change as would need to be to detect a change within an individual. These results illustrate that serum Creatinine values in veterinary medicine are subject to constraints and illustrate limitations of relying on the reference interval alone for monitoring changes in individuals.

To improve detection of significant change within a patient, example methods herein may be executed to monitor an individual and detect a change within that individual using principles of Statistical Process Control (SPC). Given that the response that will be monitored will be individual patient values, the individuals chart can be based on a Moving Range (I, MR). For example, upper and lower limits for values of test results for the individual can be determined that are based on a normal variation seen between subsequent samples. As examples, upper control limits (UCL) and lower control limits (LCL) may be determined as follows:

UCL=<X>+2.66*<MR> Equation (3)

LCL=<X>−2.66*<MR> Equation (4)

where <X> is a patient average, <MR> is an average Moving Range, and 2.66 is a constant.

A baseline for an individual may be established, and the average and average Moving Range can be calculated from the baseline. These values would then be patient-specific. This may require a large number of samples, and may not be practical for tracking patient values. Often, veterinarians either do not have results from patients at regular intervals or do not have many samples.

To address a concern of sample size and obtain an estimation of the average moving range for an individual patient, a single average moving range value can be determined from a wider population, and applied to a typical canine as follows:

<MR>=Σⱼ₌₁^{p}Σᵢ₌₂ⁿ|Xⱼᵢ−(Xⱼᵢ−1)| Equation (5)

Where p is the number of individuals in the population, n is the number of results present for each individual patient, and x is the value of an individual patient result. A wide population of canines can be used to establish what a typical within-patient variation would be, and this may be used as a constant in the calculation of control limits for each individual patient.

Within an example, the canine population used to evaluate the within-and between-patient variability above was used here, but rather than pare that population down to the middle 50%, the entire set of 244 dogs was used. For each dog, an absolute value of the difference between all subsequent values was taken. Each of these differences constitutes a single moving range calculation, and is a direct measurement of point-to-point differences for all results within all dogs. All the values for the entire population were then used to calculate a grand average value, and that value may be considered the average moving range that will be used for the application of limits to all individuals in the population. For the canine population, an Average Moving Range value of 0.2 mg/dL was determined. The formula for the Upper Control Limit, then, simplifies to: UCL=<X>+0.5, and the formula for the Lower Control Limit simplifies to LCL=<X>−0.5 (for the application of this principle to serum Creatinine in canines, the Lower Control Limit may not be of concern). In some examples, a significant change can then be determined for an individual patient if a most recent value is 0.5 mg/dL or more than the patient's previous average values.

In further examples, application of this method was performed on the patient population used throughout this analysis. All results for each patient were ordered in time series, and the UCL was calculated for each patient at each time point. A patient average was calculated as a cumulative rolling average to allow for small adjustments to an estimation of the patient average as more data becomes available for the patient according to the following:

$$〈 X 〉 = \frac{{\sum }_{i = 1}^{n} ( {X}_{i} )}{i} \qquad Equation ( 6 )$$

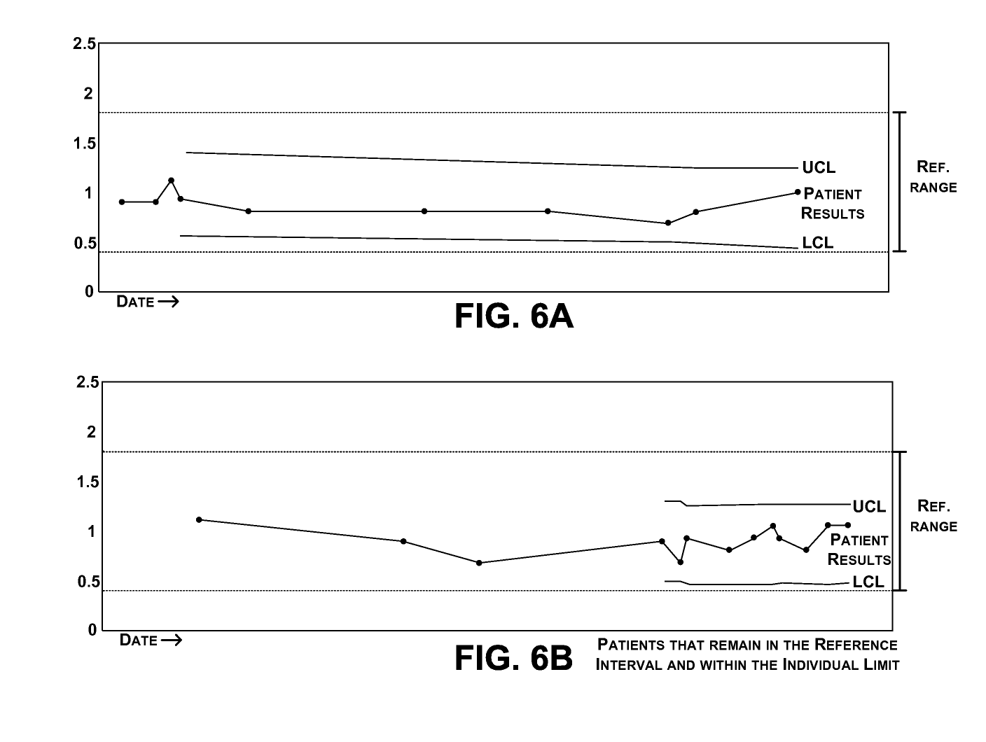

Calculation and application of the UCL was performed beginning at the fourth data point for each patient. A few examples of the application of this method are shown in FIGS. 6-9, and each example chart illustrates an instance of a theme that these charts can be grouped into. Namely, there may be four different outcomes, including (i) patients that remain in the reference range and within the individual limit, (ii) patients that breach both reference range and individual limit at the same time, (iii) patients that are out of the reference range but within the individual limit, and (iv) patients that breach the individual limit, but not the reference range.

In each of FIGS. 6-9, the patient's results are shown with the reference range and the calculated UCL and LCL for the specific patient.

FIGS. 6A-6B illustrate example charts of patients that have test results that remain in the reference interval range as well as between the UCL and LCL determined for the specific patient. For FIGS. 6A-6B, the reference range is about 0.4-1.8. In FIG. 6A, the UCL and LCL determined for the specific patient is about 1.5 and 0.5, and the patient test results over time vary but stay within the reference range and between the UCL and LCL. Such a patient may be considered to have test results within a “normal” range, for example. For Serum Creatinine testing, a diagnosis may be given that the patient does not have chronic kidney disease. In FIG. 6B, the UCL and LCL are about 1.4 and 0.5, and the patient's test results remain within the reference range and the UCL and LCL despite varying more frequently over time. The small changes may be considered acceptable since the test results remain within “normal” ranges for both the reference and UCL/LCL limits.

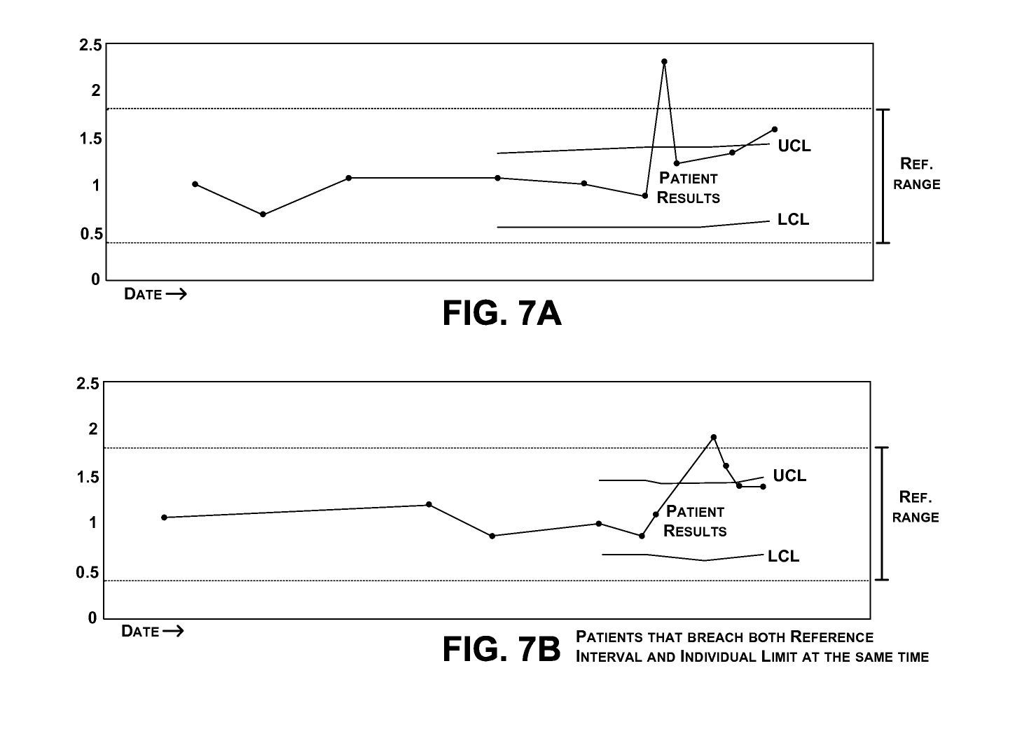

FIGS. 7A-7B illustrate example charts of patients that have test results that breach both the reference interval range as well as the UCL determined for the specific patient. For FIGS. 7A-7B, the reference range is again about 0.4-1.8. In FIG. 7A, the UCL and LCL determined for the specific patient is about 1.4 and 0.6, and the patient test results at a few specific testing instance breach both the reference range as well as the UCL. Such a patient may be considered to have test results outside of the “normal” range, for example. For Serum Creatinine testing, a diagnosis may be given that the patient is exhibiting characteristics indicative of chronic kidney disease. In FIG. 7B, the UCL and LCL are about 1.5 and 0.7, and the patient's test results breach the reference range and the UCL for a few specific testing instances.

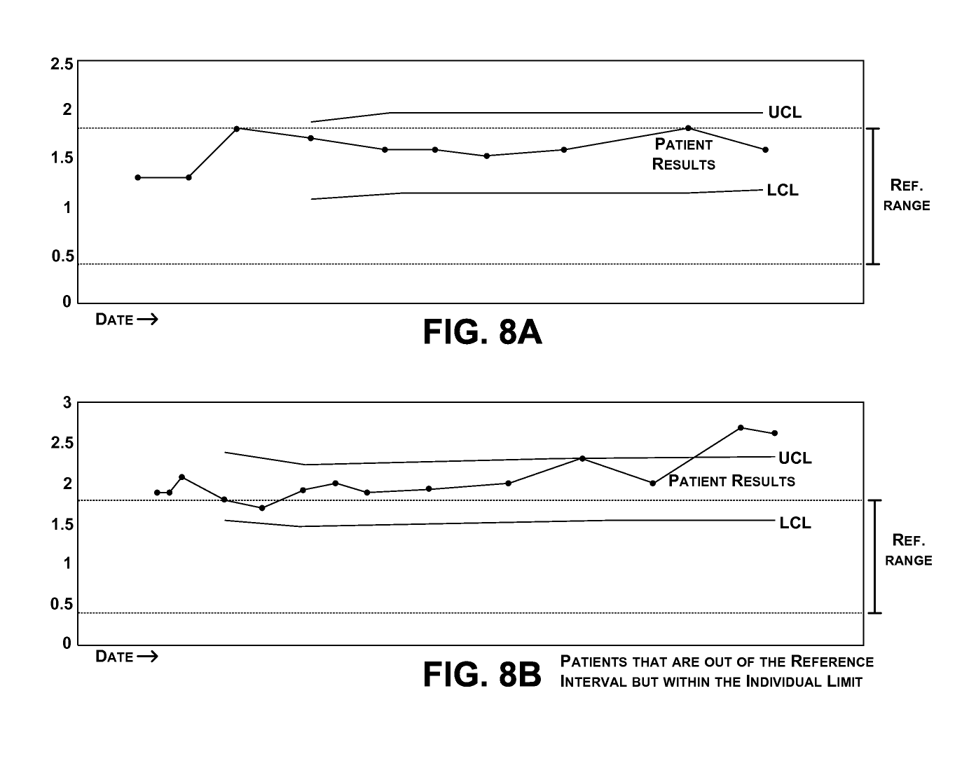

FIGS. 8A-8B illustrate example charts of patients that have test results that breach the reference interval range, but generally remain between the UCL and LCL determined for the specific patient. For FIGS. 8A-8B, the reference range again is about 0.4-1.8. In FIG. 8A, the UCL and LCL determined for the specific patient is about 2 and 1.1, and the patient test results over time vary but stay within between the UCL and LCL despite breaching the reference range (or coming very close to a breach). Such a patient may be considered to have test results within a “normal” range, for example, since the patient's test results are consistent over time and within the patient-specific UCL and LCL. Such a patient may simply have a higher acceptable range due to any number of factors, such as weight, height, gender, etc., that varies from the norm. For Serum Creatinine testing, a diagnosis may be given that the patient does not have chronic kidney disease. In FIG. 8B, the UCL and LCL are about 2.5 and 1.5, and the patient's test results breach the reference range, but remain within the UCL and LCL for most of the testing instances. Later test results are shown that breach the UCL as well. The patient in FIG. 8B may again simply have a higher acceptable range, and for test results that are consistent and within the patient-specific range, a “normal” diagnosis can be given. For later test results, where a trend is observed that the test results are moving in a direction outside of the UCL and eventually breaching the UCL, an indication or warning can be triggered that the patient is exhibiting a change that may possibly be due to an onset of kidney disease.

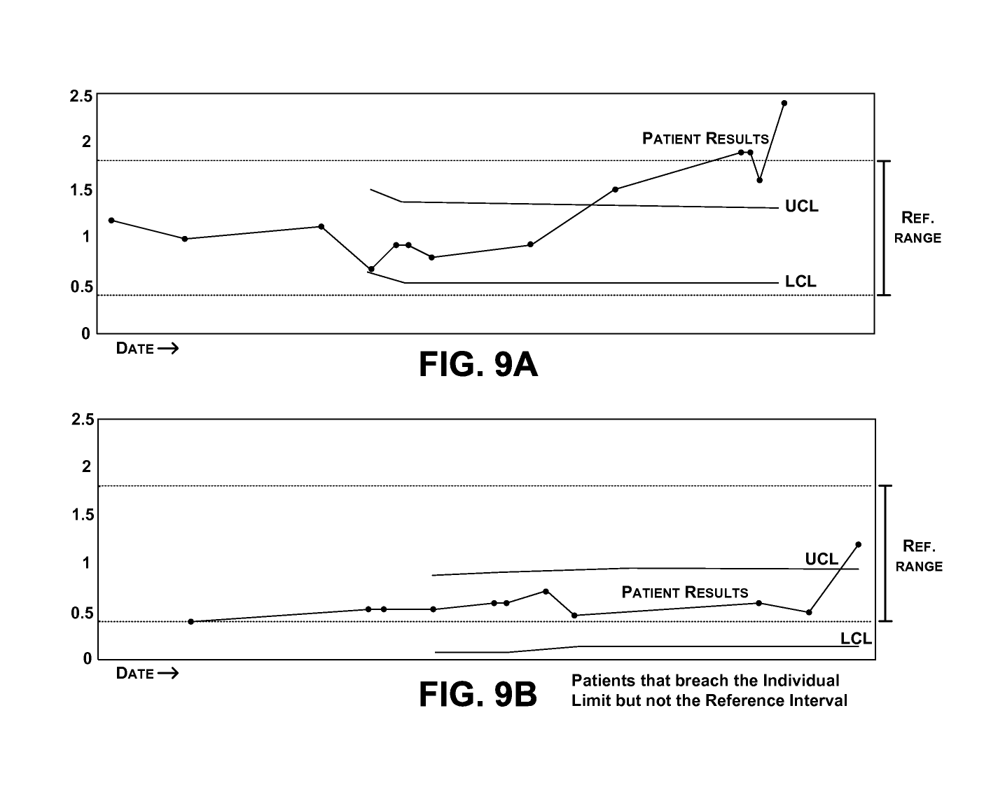

FIGS. 9A-9B illustrate example charts of patients that have test results that breach the UCL determined for the specific patient, but generally remain within the reference interval. For FIGS. 9A-9B, the reference range again is about 0.4-1.8. In FIG. 9A, the UCL and LCL determined for the specific patient is about 1.5 and 0.5, and the patient test results over time vary and eventually breach the UCL (and later breach both the UCL and reference range). Such a patient may be considered to have test results outside of a “normal” range, for example, since the patient's test results breach the patient-specific UCL. In FIG. 9B, the UCL and LCL are about 1 and 0.2, and the patient's test results remain within the reference range, but breach the UCL. The patient in FIG. 9B may have a lower acceptable range, and for test results that are consistent and within the patient-specific range, a “normal” diagnosis can be given. For later test results, where a trend is observed that the test results are moving in a direction outside of the UCL and eventually breaching the UCL, an indication or warning can be triggered that the patient is exhibiting a change that may possibly be due to an onset of kidney disease.

Table 2 below illustrates example possibilities of test results as processed or compared with both a reference range and a patient-specific limit, and an example outcome, indication, or diagnosis that may be given. As seen, contrary to what may be considered, a patient may be deemed to have abnormal test results in some situations even when the patient has test results that are within the reference range. In a similar fashion, a patient may be deemed to have normal test results even when the patient has test results outside of the reference range. In some instances, an outcome of normal may be dependent upon patient test results being an acceptable amount outside of the reference range, for example.

TABLE 2

| Reference Range | Individual Limit | Outcome |
|---|---|---|
| Within | Within | Normal |
| Within | Outside | Abnormal |
| Outside | Within | Normal |
| Outside | Outside | Abnormal |

As shown in patients above, application of patient-specific limits is able to identify significant change for the patient prior to a breach of the wider reference interval.

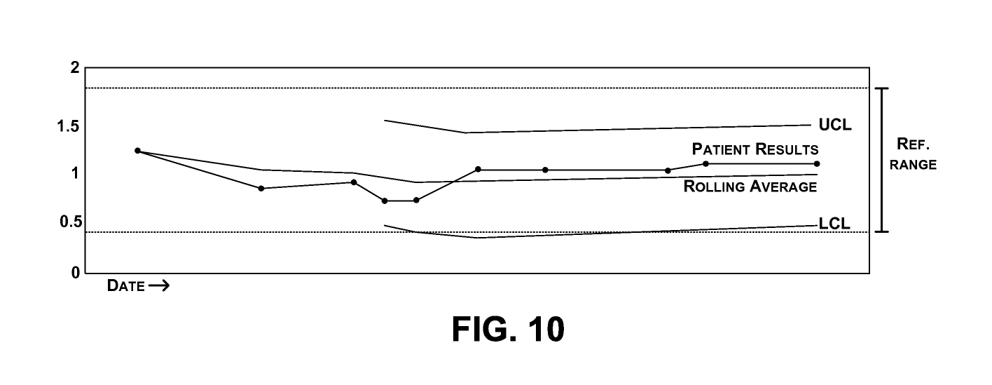

FIG. 10 illustrates another example chart of a patient that has test results that remain within the UCL and LCL determined for the specific patient, and within the reference interval. In FIG. 10, in addition, a rolling cumulative moving average is determined and illustrated. In some examples, to determine the rolling cumulative moving average, each test result may be compiled with all test results to calculate the average, which will change over time. In other examples, some test results may be ignored for purposes of calculating the cumulative moving average, such as any test results that that breach the UCL (which may be considered anomalies from the perspective of a patient average) or any test results that are considered to be anomalous, such as being twice a previous value, for example. Such anomalous test results may serve to unduly influence the average, for example.

In addition, within examples herein, a patient's UCL and LCL may vary over time and a “new normal” can be established for a patient. As an example, there may be times when a patient has a shift that is sustained, and such as demonstrating a change in test results that is sustained for two or more testing instances. Changing of the UCL and LCL could be a user-designated choice as well. Additional consideration can be made as to elapsed time between test results, for example, when a large amount of time exists between test results, less emphasis can be placed on the prior test result.

Within examples herein, using both reference and patient-specific data to render a diagnosis may be applied to testing of serum Creatinine in canine and feline patients. However, such testing methodology can be applied to other testing procedures as well where test results vary between “within-patient” results and “between-patient” results. In further examples, the diagnosis may be provided in any number of forms, such as a written report, a message to a device, an email, a display on a device, etc.

Any of the example methods described herein may be performed by a medical device (as shown in FIG. 1), or any computing device, or portions of functions of the methods may be performed by a server that is in communication with such devices. As an example implementation, a computing device may receive test results of a patient from a server, device, or other testing equipment at a lab, and then may access another server or database to retrieve previous test results, reference data, and patient-specific data to perform functions of method 200 in FIG. 2 or method 300 in FIG. 3). The computing device may generate a report, and can be programmed to send or provide the report to the doctor or to the patient, and the sending of the report to the patient can be based on whether the test results are deemed positive or negative.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that terminology used herein is for the purpose of describing particular embodiments, and is not intended to be limiting.

What is claimed is:

1. A method comprising:
obtaining, by a computing device, a result of a diagnostic test performed on a patient;
comparing, by the computing device, the result to patient-specific data, wherein the patient-specific data includes one or more previous test results of the diagnostic test previously performed on the patient; and
providing, by the computing device, an indication indicative of an abnormal test result based on the result being in a normal range of reference data and having a variance from the patient-specific data of a threshold amount, wherein the reference data is based on testing of a group of patients.

2. The method of claim 1, further comprising:
comparing a value of the result with the reference data, wherein the reference data has a range of values associated as low, normal, and high; and
associating the value of the result with one of the low, normal, and high range of values.

3. The method of claim 1, wherein the diagnostic test includes a measurement of serum Creatinine in a canine patient.

4. The method of claim 1, further comprising:
determining a threshold variation between subsequent test results of the diagnostic test performed on the patient; and
determining the variance of the patient-specific data from the threshold amount based on the threshold variation between subsequent test results being present.

5. The method of claim 1, further comprising:
determining a trend of the result of the diagnostic test performed on the patient and the one or more previous test results of the diagnostic test previously performed on the patient; and
providing the indication based on the result being in the normal range of the reference data and having the trend being in a direction toward outside the normal range of the reference data.

6. The method of claim 1, further comprising:
determining, based on the patient-specific data, one or more of an upper and a lower limit of a value of the result of the diagnostic test for the patient; and
providing the indication based on the result being in the normal range of the reference data and being outside of one of the upper and the lower limit of the value of the result of the diagnostic test.

7. The method of claim 6, further comprising determining the one or more of the upper and the lower limit of the value of the result of the diagnostic test based on a mass of the patient.

8. The method of claim 1, further comprising:
determining, based on the patient-specific data, one or more of an upper and a lower limit of a value of the result of the diagnostic test for the patient;
determining a moving range based on the result of the diagnostic test performed on the patient in order to calculate one or more of the upper and the lower limit; and
wherein comparing the result comprises determining whether the result is within the upper and the lower limit.

9. The method of claim 8, further comprising:
modifying an average value of the patient-specific data to produce a cumulative rolling average;
determining an average moving range based on a population of patients and modifying the upper and the lower limit of the value for the patient based on the average moving range; and
wherein comparing the result comprises determining whether the result is within the upper and the lower limit.

10. The method of claim 9, wherein modifying the average value based on the result to produce the cumulative rolling average comprises:
modifying the average value based on values of the result, for values other than values that are outside of the upper limit and for values other than values that are above a given threshold amount of a previous test result.

11. A computer readable storage medium having stored therein instructions, that when executed by a computing device, cause the computing device to perform functions comprising:
obtaining a result of a diagnostic test performed on a patient;
comparing the result based on patient-specific data, wherein the patient-specific data includes one or more previous test results of the diagnostic test previously performed on the patient; and
providing an indication indicative of an abnormal test result based on the result being in a normal range of reference data and having a variance from the patient-specific data of a threshold amount, wherein the reference data is based on testing of a group of patients.

12. The computer readable storage medium of claim 11, wherein the functions further comprise:
determining a threshold variation between subsequent test results of the diagnostic test performed on the patient; and
determining the variance of the patient-specific data from the threshold amount based on the threshold variation between subsequent test results being present.

13. The computer readable storage medium of claim 11, wherein the functions further comprise:
determining a trend of the result of the diagnostic test performed on the patient and the one or more previous test results of the diagnostic test previously performed on the patient; and
providing the indication based on the result being in the normal range of the reference data and having the trend being in a direction toward outside the normal range of the reference data.

14. The computer readable storage medium of claim 11, wherein the functions further comprise:
determining, based on the patient-specific data, one or more of an upper and a lower limit of a value of the result of the diagnostic test for the patient; and
providing the indication based on the result being in the normal range of the reference data and being outside of one of the upper and the lower limit of the value of the result of the diagnostic test.

15. The computer readable storage medium of claim 11, wherein the functions further comprise:
determining, based on the patient-specific data, one or more of an upper and a lower limit of a value of the result of the diagnostic test for the patient;
determining a moving range based on the result of the diagnostic test performed on the patient in order to calculate one or more of the upper and the lower limit; and
wherein processing the result based on the patient-specific data comprises processing the result to determine whether the result is within the upper and the lower limit.

16. A system, comprising:
at least one processor; and
data storage comprising instructions executable by the at least one processor to cause the system to perform functions comprising:
obtaining a result of a diagnostic test performed on a patient;
comparing the result based on patient-specific data, wherein the patient-specific data includes one or more previous test results of the diagnostic test previously performed on the patient; and
providing an indication indicative of an abnormal test result based on the result being in a normal range of reference data and having a variance from the patient-specific data of a threshold amount, wherein the reference data is based on testing of a group of patients.

17. The system of claim 16, wherein the functions further comprise:
comparing a value of the result with the reference data, wherein the reference data has a range of values associated as low, normal, and high; and
associating the value of the result with one of the low, normal, and high range of values.

18. The system of claim 16, wherein the functions further comprise:
determining, based on the patient-specific data, one or more of an upper and a lower limit of a value of the result of the diagnostic test for the patient based on a mass of the patient;
providing the indication based on the result being in the normal range of the reference data and being outside of one of the upper and the lower limit of the value of the result of the diagnostic test.

19. A method comprising:
obtaining, by a computing device, a result of a diagnostic test performed on a patient;
comparing, by the computing device, the result based on patient-specific data, wherein the patient-specific data includes one or more previous test results of the diagnostic test previously performed on the patient; and
providing, by the computing device, an indication indicative of a normal test result based on the result being outside a normal range of reference data and being between an upper limit and a lower limit of the patient-specific data, wherein the reference data is based on testing of a group of patients.

20. The method of claim 19, wherein the upper limit and the lower limit of the patient-specific data are representative of a range of a portion of values of the patient-specific data.
